(19) United States
(12) Patent Application Publication
(10) Pub. No.: US 2009/0136406 A1
(43) Pub. Date: May 28, 2009

(54) FLAMELESS THERMAL OXIDATION METHOD

(75) Inventors: Bruce Carlyle Johnson, Broken Arrow, OK (US); Nathan Steneck Petersen, Tulsa, OK (US)

Correspondence Address: HOVEY WILLIAMS LLP, 10801 Mastin Blvd., Suite 1000, Overland Park, KS, 66210, US

(73) Assignee: John Zink Company, L.L.C, Tulsa, OK (US)

(21) Appl. No.: 11/945,775

(22) Filed: Nov. 27, 2007

(51) Int. Cl. B01D 53/44

(52) U.S. Cl. 423/245.3

(57) ABSTRACT

A thermal oxidizer is provided in which off-gases in a process stream are thermally oxidized within substantially the entire interior volume of an oxidation chamber. The thermal oxidation is conducted without the presence of a flame or with only a minor portion of the fuel being combusted in a flame.

### BACKGROUND OF THE INVENTION

This invention relates generally to thermal oxidizers used to oxidize organic compounds in process streams and, more particularly, to methods of operating such thermal oxidizers using flameless thermal oxidation to decompose the organic compounds.

Thermal oxidizers are commonly used to oxidize one or more gases or vapors in a process stream by subjecting them to high temperatures before release of the process stream to the atmosphere. The gases in the process stream are commonly referred to as off-gases and typically consist of volatile organic compounds (VOCs), semi-volatile organic compounds (SVOCs), and/or hazardous air pollutants (HAPs). The process stream containing the off-gases is frequently a byproduct of an industrial, manufacturing, or power generating process.

In a conventional thermal oxidizer, the off-gases are oxidized to form carbon dioxide and water by combining the process stream with a gas stream that contains oxygen and then passing the combined stream through a flame or combustion gases produced by burning a fuel source such as natural gas. In this manner, the thermal oxidizer converts environmentally objectionable organic compounds into harmless compounds that may be safely exhausted to the atmosphere.

The use of a flame to cause thermal decomposition of compounds in thermal oxidizers, however, often results in the production of objectionable levels of air pollutants such as NOx and CO. NOx is produced as a result of localized areas of high temperature and CO is the result of incomplete combustion of the fuel gas that may occur during the combustion process in the thermal oxidizer.

In an effort to reduce the levels of NOx and CO produced during thermal decomposition of compounds, it is known to use a flameless oxidation process in a thermal oxidizer. An example of a flameless oxidation process using a bed matrix of solid heat-resistant material is disclosed in U.S. Pat. No. 5,165,884. In that patent, a mixture of gases or vapors with air and/or oxygen flows into the bed matrix which has been preheated to a temperature above the autoignition temperature of the mixture. The mixture ignites and reacts exothermally in the bed matrix to form a self-sustaining reaction wave within the bed matrix. The process is used to minimize production of NOx, CO, and other products of incomplete combustion during destruction of a particular gas or vapor in a process stream prior to release of the process stream to the atmosphere. Emission levels of thermal-NOx of less than 0.007 lb of NOx (as NO₂) per million BTU and CO levels below 10 ppm are said to be obtainable using the described method.

The bed matrix in the above-described U.S. Pat. No. 5,165,884 is advantageous in that it anchors and stabilizes the reaction wave during the combustion process. The bed matrix, however, occupies a substantial portion of the internal volume of the process reactor, thereby reducing the open volume available for flow of the process stream. The reduction in open volume reduces the available residence time for a given throughput, thus reducing the time for destruction of hazardous wastes. In addition, the bed matrix creates a substantial pressure drop that adds to the operating costs of the process because the process stream must be subjected to an increased pressure before it enters the process reactor. This pressure drop tends to increase over time as particulate matter from the process stream accumulates in the bed matrix or the bed material degrades due to thermal shock. Eventually, the increase in pressure drop across the bed matrix may require replacement of the bed material.

A need has thus developed for a thermal oxidizer that generates low levels of NOx and CO without the disadvantages described above.

### SUMMARY OF THE INVENTION

The present invention provides a method for thermally oxidizing components of a fluid stream in an oxidation chamber having an internal refractory lining which supplies the radiant heat for causing the flameless thermal oxidation of the components in the fluid stream. The method comprises heating the refractory lining in the oxidation chamber to a preselected temperature which is above the temperature required to cause flameless thermal oxidation of the components in the fluid stream. After the refractory lining is heated to the preselected temperature, the fluid stream is then passed through the oxidation chamber under conditions to cause the flameless thermal oxidation of the components in the fluid stream as a result of thermal radiation from the refractory lining. The present method thus relies on thermal radiation from the refractory lining to cause the flameless thermal oxidation and does not require a bed matrix or flue gas recirculation as required by conventional flameless oxidation processes.

In one embodiment, one or more fuel components in the fluid stream are combusted in a visible flame to cause the initial heating of the refractory lining to the preselected temperature. The overall concentration of the fuel components in the fluid stream can be within the flammability range during this startup mode. Alternatively, the overall concentration of the fuel components is outside of the flammability range, but a flammable mixture results by not completely mixing the fuel components with the combustion air which is present in the fluid stream so that a diffusion or partially premixed flame results. During flameless thermal oxidation mode, the concentration of the fuel components is outside of the flammability range and the fuel and combustion air are sufficiently mixed to prevent combustion of the mixture in a visible flame within the burner.

Volatile organic compounds, semi-volatile organic compounds, and/or hazardous air pollutants may be present as additional components in the fluid stream and are thermally oxidized during the flameless thermal oxidation mode. These additional components typically originate in a process stream from an industrial, manufacturing, or power generating process and must be removed prior to release of the process stream to the atmosphere. The process stream can supply some, all, or none of the combustion air required in the process.

If needed, supplemental heat can be added to the oxidation chamber to offset thermal losses through an external shell of the oxidation chamber or the cooling effect of the fluid stream. The supplement heat can be added continuously, such as by burning one or more fuels in another fluid stream in the oxidation chamber in a visible flame. Alternatively, the supplemental heat can be added intermittently, such as by periodically operating the thermal oxidizer in the initial heating mode.

When the process of the present invention is operating in flameless oxidation mode, levels of NOx and CO below 1 ppm dry have been achieved. Even when supplemental heat is added to the oxidation chamber, NOx levels between 1 and 12 ppm dry and CO levels below 1 ppm dry have been obtained.

### BRIEF DESCRIPTION OF THE SEVERAL VIEWS OF THE DRAWINGS

In the accompanying drawings which form part of the specification and are to be read in conjunction therewith and in which like reference numerals are used to indicate like parts in the various views:

FIG. 1 is a top elevation view of a thermal oxidizer in accordance with one embodiment of the present invention with portions of the thermal oxidizer broken away to show details of construction; and

FIG. 2 is an enlarged side elevation view, taken in vertical section, of a burner portion of the thermal oxidizer with certain portions shown schematically.

### DETAILED DESCRIPTION OF THE INVENTION

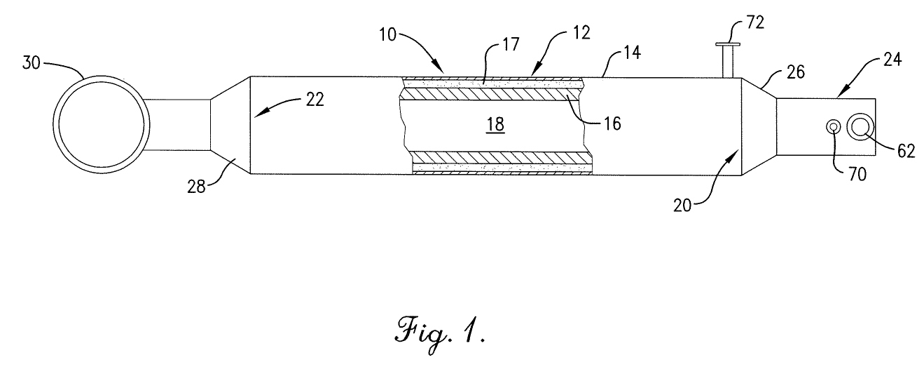

Turning now to the drawings in greater detail and initially to FIG. 1, one embodiment of a thermal oxidizer useful in the flameless thermal oxidation of components in a fluid stream is broadly represented by the numeral 10. The fluid stream is designated by an arrow 11 and typically is a gas or vapor stream. The oxidizable components in the fluid stream 11 can be in gas, liquid, and/or solid particulate form. Examples of these components include fuels, waste products, organic compounds, including volatile organic compounds and semi-volatile organic compounds, and/or hazardous air pollutants.

Thermal oxidizer 10 comprises a thermal oxidation chamber 12 having an exterior shell 14 lined with one or more layers of a refractory lining 16. The refractory lining 16 may be in castable, plastic, brick, blanket, fibrous, or any other suitable form and typically comprises primarily ceramic materials made from combinations of high-melting oxides such as aluminum oxide, silicon dioxide, or magnesium oxide. The innermost or “hot face” refractory lining 16 is preferably backed with a lower thermal conductivity lining 17 to further reduce thermal losses through the exterior shell 14.

The internal area within the lined shell 14 defines an open interior volume 18 within which the flameless thermal oxidation occurs, as more fully described below. The open interior volume 18 is sized so that the desired residence time is obtained for the fluid stream 11 flowing through the thermal oxidation chamber 12 at the intended volumetric flow rate for the specific process applications being performed. Normally, the residence time is selected so that complete combustion and/or the desired destruction removal efficiency is obtained for the oxidizable components in the process stream.

The shell 14 is preferably cylindrical and horizontally oriented, but it may alternatively have a cross section which is of a polygonal or other configuration and/or it may be oriented vertically or at an intermediate angle. The shell 14 has an at least partially open upstream end 20 and an opposite, at least partially open, downstream end 22. The terms “upstream” and “downstream” are used with reference to the intended direction of flow of the fluid stream 11 through the oxidation chamber 12 during operation of the thermal oxidizer 10.

Thermal oxidizer 10 further includes a burner 24 connected to the upstream end 20 of the thermal oxidation chamber 12 by an optional transition 26. The downstream end 24 of chamber 12 is connected by a similar optional transition 28 to an exhaust stack 30 through which the flue gas reaction products resulting from the thermal oxidation process are released to the atmosphere.

Burner 18 is preferably a forced draft burner that generates a strong vortex to insure thorough premixing of combustion air and fuel gas. Burner 18 is preferably fueled by a gas, typically natural gas, but other fuel gases such as hydrogen, methane, ethane, propane, butane, carbon monoxide, and various blends thereof, can be used. Various additives and diluents, such as nitrogen, carbon dioxide, and/or water vapor can also be added to or are present in the gas. Some or all of the fuel may be in liquid or solid particulate form. Other types of burners can also be used.

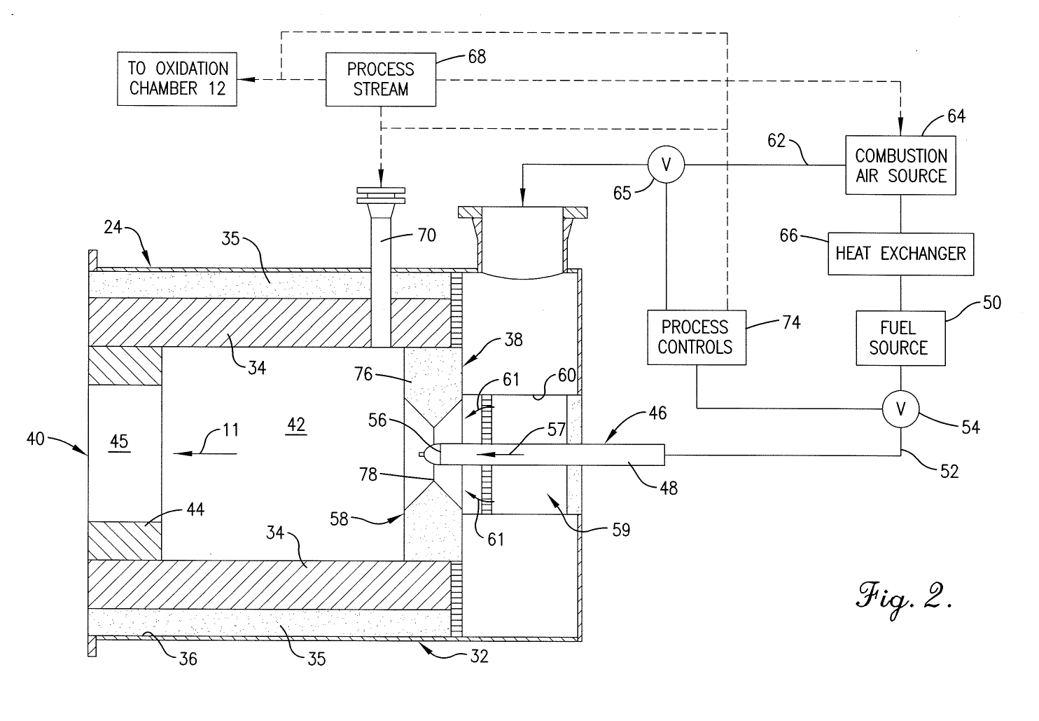

As can best be seen in FIG. 2, in the illustrated embodiment, burner 24 comprises an exterior housing 32 which is lined with one or more layers of a refractory lining 34 of the type previously described. An insulating lining 35 may also be placed between the hot face refractory lining 34 and the inner surface of the exterior housing 32. The housing 32 is preferably cylindrical, but can have a cross section which is of polygonal or other configuration. The housing 32 has a sidewall 36 and opposed upstream and downstream ends 38 and 40, respectively. The lined housing 32 defines an open interior burner chamber 42 which is in fluid-flow communication with the oxidation chamber 12 positioned downstream from the burner 24. A choke 44 formed of refractory material may be positioned at the downstream end 40 of the burner housing 32 to provide a reduced diameter passageway 45 from the burner chamber 42 to the downstream oxidation chamber 12. The choke 44 may have the rectangular cross section as illustrated in the drawings or it may be formed with inwardly sloping inlet and outlet ends to form a more aerodynamic structure.

A nozzle assembly 46 is positioned at the upstream end 38 of the burner housing 32 for delivery of a combustible fuel and air mixture into the burner chamber 42. In one embodiment, nozzle assembly 46 comprises an elongated, centrally-positioned fuel gun 48 which is supplied with fuel from a fuel source 50 by a conduit 52. A suitable flow regulator 54 regulates the volumetric flow rate of fuel through the fuel gun 48. The fuel gun 48 terminates in a fuel tip 56 having orifices (not shown) through which a fuel stream designated by arrow 57 is discharged into the burner chamber 42. The fuel gun 48 is preferably moveable in an axial direction so that the positioning of the fuel tip 56 may be varied in relation to a surrounding throat structure 58 of reduced cross-sectional area, as more fully described below.

The fuel gun 48 is surrounded by an annular combustion air plenum 59 in which a plurality of swirl vanes 60 are positioned. An oxygen-containing combustion air stream designated by arrow 61 flows into the combustion air plenum 59 and then through the swirl vanes 60 before being introduced into the burner chamber 42. The swirl vanes 60 impart an intense rotary motion to the combustion air stream to cause mixing of the combustion air with the fuel stream discharged from the fuel tip 56. Combustion air is supplied to the combustion air plenum 59 by a conduit 62 from a combustion air source 64 and the volumetric flow rate is regulated by a flow regulator 65. Other mechanisms may be used to impart the desired mixing of the fuel stream 57 with the combustion air stream 61. As but one example of such mechanisms, the combustion air stream 61 may be delivered into the combustion air plenum 59 through one or more angled discharge nozzles which impart a rotary motion to the combustion air. It is to be understood that a swirling motion need not be imparted to the fuel stream 57 or combustion air stream 61 so long as sufficient turbulence is created to cause intimate mixing of the fuel stream 57 and combustion air stream 61.

The combustion air stream 61 and/or the fuel stream 57 may be supplied to the burner 24 at ambient temperatures. Alternatively, the combustion air stream 61 and/or the fuel stream 57 may be preheated by a heat exchanger 66 in which heat is supplied by the combustion process occurring within the thermal oxidizer 10 or from other suitable sources. The combustion air stream 61 and fuel stream 57 are preferably supplied to the burner 24 at sufficient pressure to force the fluid stream 11 to flow forwardly through the oxidation chamber 12 without recirculating.

The source 64 of the combustion air stream 61 may comprise a portion, or all, of a process stream 68 containing waste products, organic compounds, including volatile organic compounds and semi-volatile organic compounds, and/or hazardous air pollutants. Examples of these compounds and pollutants include hydrocarbons, sulfur compounds, chlorinated solvents, halogenated hydrocarbon liquids, dioxins, and polychlorinated biphenyls. The process stream 68 may thus be an off-gas or byproduct of an industrial, manufacturing, or power generating process. Depending on the specific nature and oxygen content of the process stream 68, the source 64 of the combustion air stream may also comprise atmospheric air or some additional source of oxygen. In addition, one or more portions, or all, of the process stream 68 may bypass the combustion air plenum 59 and may be delivered to the burner chamber 42 and/or the oxidation chamber 12 at one or more downstream locations, such as through injection ports 70 and 72. Suitable process controls 74 are used to monitor and regulate the volumetric flow rates of the various fluid streams.

The throat structure 58 is positioned at the upstream end 38 of the burner chamber 42 and, in one embodiment, comprises an annular wall 76 that converges or tapers inwardly from both ends to a throat 78 of reduced cross-sectional area. The throat structure 58 is positioned downstream from the swirl vanes 60 so that the combustion air stream 61 discharged through the swirl vanes must pass through the throat structure 58 before entering the burner chamber 42.

During startup mode, the fuel tip 56 is positioned so that the fuel stream 57 is discharged from the fuel tip 56 at a first location downstream from a centerline of the throat 78. The combustion air stream 61 is discharged from the swirl vanes at a second location which is a preselected distance upstream from the first discharge location of the fuel stream 57 so that the two streams are first mixed together at or downstream from the throat 78. At preselected combustion air to fuel ratios, positioning of the fuel tip 56 downstream from the throat 78 limits complete mixing of the fuel and combustion air and allows the fuel to be combusted with a visible flame within the burner chamber 42. Depending on flow conditions, the flame may extend from the burner chamber 42 into an upstream portion of the oxidation chamber 12. As the hot combusted gases flow through the oxidation chamber 12, the refractory lining 16 of the oxidation chamber 12 is heated to a preselected temperature which is capable of sustaining flameless thermal oxidation of the specific fuel and air mixture flowing through the oxidation chamber 12. When natural gas is used as the fuel source, the present method has been demonstrated to operate successfully within the preselected temperature range of about 1,900 degrees F. to about 2,300 degrees F. With further optimization of the method, it is believed that the preselected temperature range can be extended to from about 1,450 degrees F. to about 2,600 degrees F.

After the refractory material 16 reaches the preselected temperature, the process switches from startup mode to a flameless thermal oxidation mode in which components of the fluid stream 11 flowing through the oxidation chamber 12 are thermally oxidized. In the illustrated embodiment, the switch from startup to flameless thermal oxidation mode is achieved by moving the fuel tip 56 upstream from the throat 78. This movement of the fuel tip 56 causes the fuel stream 57 to be discharged from the fuel tip 56 at a second location which is closer to the discharge location for the combustion air stream 61. The fuel stream 57 and swirling combustion air stream 61 are thus initially mixed at a location upstream from the throat 78 to allow more complete mixing of the fuel and combustion air stream as the mixture passes through the throat 76. As a result of the more complete mixing of the fuel and combustion air streams 57 and 61, the air to fuel ratio throughout the mixture is below the lower flammability limit and the visible flame is extinguished in the burner chamber 42. The fuel and combustion air mixture nonetheless continues to thermally oxidize without a flame within the oxidation chamber 12 as a result of the thermal radiation from the refractory lining 16 in the oxidation chamber 12 and without the need for flue gas recirculation and/or the use of a bed matrix within the oxidation chamber 12 as required in prior art processes. After the visible flame is extinguished, the NOx level in the flue gas drops dramatically, including to a level of less than 1 ppm dry, without an increase in CO levels.

It is to be understood that switching from startup to flameless oxidation mode can also be achieved by other methods. For example, the combustion air to fuel ratio can be adjusted so that it is sufficiently outside of the flammability range to extinguish the visible flame used during the startup mode. The process may also cycle between that startup and flameless oxidation modes at preselected intervals, such as when additional heat is required in the oxidation chamber 12 in situations where the refractory lining 16 cools below the temperature required to sustain flameless thermal oxidation of the components in the fluid stream 11. This cooling can result from thermal loses through the exterior shell 14 of the oxidation chamber 12 or from the cooling effect of the fuel, combustion air, and/or process streams 57, 61, and 68.

Depending on the conditions of the specific process and equipment being used, the flameless thermal oxidation can be self-sustaining for a period of time, such as one hour or longer, including indefinitely. In other applications, as noted above, supplemental heat may need to be added to the oxidation chamber 12 to offset thermal losses through the exterior shell 14 and the cooling effect of one or more of the fuel, combustion air, and/or process streams 57, 61, and 68 which are delivered to the burner 24 or oxidation chamber 12 at temperatures below that at which flameless oxidation is occurring. The supplemental heat could be added, for example, by continuously or intermittently preheating the fuel, combustion air, and/or process streams, introducing supplemental fuel into the oxidation chamber 12 through one or more injection ports and burning the supplemental fuel in a flame mode, electrical resistance heating elements, and/or by intermittently operating the burner 24 in the initial heating mode. Adding this supplemental heat by burning fuel with a visible flame may cause an increase in the NOx and CO levels, but the overall levels will remain significantly below those that would result from operating the thermal oxidizer 10 by continual burning of all the fuel with a visible flame.

During operation of the thermal oxidizer 10 in flameless oxidation mode, the fuel stream 11 comprising the fuel and combustion air streams 57 and 61 and, optionally, the process stream 68, is delivered to oxidation chamber 12 as a premixed mixture with a combustion air to fuel ratio selected for the desired operating conditions in specific applications. Generally, the combustion air to fuel ratio should be below the lower flammability limit for the specific fuel being utilized. For example, when using natural gas comprising approximately 95% methane as the fuel, a combustion air to fuel ratio of approximately 20:1 or greater can be used. As long as the combustion air and fuel concentrations are outside of the flammability range at their mixture temperature within the burner chamber 42 and are thoroughly premixed in the fluid stream 11 flowing through the oxidation chamber 12, the resulting thermal oxidation within the oxidation chamber 12 will be flameless. Diluents such as nitrogen, carbon dioxide, and/or water vapor can be injected into the burner chamber 42 to lower the fuel concentration and/or temperature and thereby stay below the lower flammability limit to reduce the opportunity for undesirable flashback into the burner chamber 42. The choke 44, if present, further reduces the opportunity for flashback by increasing the velocity of the fluid stream 11 flowing from the burner chamber 42 into the oxidation chamber 12 and shields the burner chamber 42 from radiation emanating from the oxidation chamber 12.

The components of the fluid stream 11 which are thermally oxidized in the flameless process described above can be any compounds capable of undergoing thermal oxidation, such as fuels, waste materials, organic compounds, including volatile organic compounds and semi-volatile organic compounds, and various types of hazardous air pollutants. In situations where it is desired for the thermal oxidizer 10 to operate merely as a burner, one or more fuels would be the components in the fluid stream 11 which undergo thermal oxidation. In other words, the present invention encompasses processes where the thermal oxidizer 10 is not acting to remove pollutants from a process stream, but is instead serving as a low NOx and low CO burner which provides hot flue gases for other uses, such as heat exchange in a boiler.

The burner 24 provides a convenient mechanism for preheating the oxidation chamber 12 and for subsequently premixing the fuel and combustion gas prior to delivery to the oxidation chamber 12. It is to be understood, however, that the oxidation chamber 12 can be preheated by other heat sources in place of or in addition to the burner 24. In addition, the fuel and combustion air can be premixed by other mechanisms prior to entry into, or as they enter, the oxidation chamber 12. Thus, the present invention encompasses processes where the burner 24 need not be used and the heat is supplied in other ways, or where the burner is a diffusion or partial premixed burner.

The process of the present invention does not require the use of a bed matrix of the type used in conventional process for operating thermal oxidizers. Thus, all or substantially all of the open internal volume 18 of the oxidation chamber 12 is available for the flow of the fluid stream 11 undergoing flameless thermal oxidation. As a result, the previously discussed disadvantages of the bed matrix are avoided in the present process, which nonetheless is capable of achieving very low NOx and CO levels. While a bed matrix is not necessary in the flameless thermal oxidation process of the present invention, it may be desirable in certain applications to include a bluff body or other mixing device within the oxidation chamber 12 to facilitate the mixing of the fluid stream 11 and/or to anchor the flame, if used, which supplies supplemental heat.

The following examples are provided by way of illustration and are not to be taken as a limitation on the overall scope of the present invention.

### EXAMPLE 1

Combustion air in the form of air at room temperature was delivered into the burner chamber 42 through swirl vanes 60 at a flow rate of 114,000 scf/hr. Fuel in the form of natural gas at room temperature was injected into the burner chamber 42 through the fuel tip 56 at a flow rate of 5,550 scf/hr. The fuel and combustion air mixture was ignited and burned with a visible flame until the oxidation chamber 12 reached a temperature of 1,880 degrees F. Once the oxidation chamber 12 was preheated in this manner, the burner flame was extinguished by pulling the fuel tip 56 back from the centerline of the burner throat 78 approximately 3.5 inches to cause more complete mixing of the fuel and combustion air prior to passage of the mixture through the burner throat 78. The fuel and combustion air flow rates remained unchanged and the premix stream of fuel and combustion air passed into the burner chamber 42 through the burner throat 78 without a visible flame being present and the combustion roar that had accompanied the burning of the fuel in the flame mode disappeared. The fuel continued to oxidize in a stable flameless oxidation process as a result of thermal radiation from the preheated refractory lining 16 of the oxidation chamber 12. The flameless oxidation process was substantially in equilibrium and NOx levels of less than 1 ppm dry and CO levels of less than 1 ppm dry were measured. The process ran for 8.5 hours and was shut down when the temperature in the oxidation chamber 12 just downstream from the burner 24 cooled to a temperature of 1,500 degrees F. as a result of thermal losses through the exterior shell 14 of the oxidation chamber 12 and the cooling effect of the fuel and combustion air being delivered to the burner 24 at ambient temperatures. The outlet temperature of the oxidation chamber 12 was still at 1,880 degrees F. when the process was shut down.

### EXAMPLE 2

The test of Example 1 was repeated with the following changes in parameters: (1) the combustion air flow rate was reduced to 100,200 scf/hr., and (2) the fuel flow rate through the burner chamber 42 was reduced by staging the fuel. The total fuel flow was 5,500 scf/hr. and was split with 85.6% of the fuel being premixed with all of the combustion air stream prior to injection into the burner chamber 42 and the remaining 14.4% of the fuel being injected through two fuel gas tips positioned in the oxidation chamber 12 just downstream from the burner 24. The fuel injected through the fuel gas tips into the oxidation chamber 12 was combusted with a visible flame and provided direct heating of the refractory lining 16 to stabilize the flameless oxidation process in the oxidation chamber 12. As a result of this increased heat input, the outlet temperature of the oxidation chamber 12 was 1,990 degrees F. As a result of the combustion of a portion of the fuel with a visible flame, the NOx levels increased and varied from 6 to 12 ppm dry. The CO levels remained below 1 ppm dry. The test was intentionally terminated at 44.5 hours of operation as it appeared that the process was self-sustaining.

Subsequent tests have shown that even higher operating temperatures of approximately 2,000 degrees F., 2,100 degrees F., 2,200 degrees F., and 2,300 degrees F. can be achieved without exceeding the flammability limits in the burner chamber 42 by staging the fuel to the gas tips downstream from the burner 24. NOx and CO levels below 1 ppm dry have been obtained even at approximately 2,000 degrees F. at flow rates that cause intimate mixing of the fluid stream 11 with the staged fuel in the oxidation chamber 12.

From the foregoing, it will be seen that this invention is one well adapted to attain all the ends and objectives hereinabove set forth together with other advantages which are inherent to the structure.

It will be understood that certain features and subcombinations are of utility and may be employed without reference to other features and subcombinations. This is contemplated by and within the scope of the invention.

Since many possible embodiments may be made of the invention without departing from the scope thereof, it is to be understood that all matter herein set forth or shown in the accompanying drawings is to be interpreted as illustrative and not in a limiting sense.

Having thus described the invention, what is claimed is:

1. A method for thermally oxidizing components of a fluid stream in an oxidation chamber having an internal refractory lining, said method comprising the steps of:
(a) heating said refractory lining in the oxidation chamber to a preselected temperature; and
(b) then passing said fluid stream through said oxidation chamber under conditions to cause flameless thermal oxidation of said components in said fluid stream as a result of thermal radiation from said refractory lining.

2. The method of claim 1, including the step of combusting said components in said fluid stream in a visible flame to cause said heating of said refractory lining.

3. The method of claim 1, including the step of including one or more fuels among said components in said fluid stream and maintaining a concentration of said one or more fuels in said fluid stream outside of a flammability range while said fluid stream is passing through said oxidation chamber.

4. The method of claim 3, including maintaining the concentration of said one or more fuels below the lower flammability limit while said fluid stream is passing through said oxidation chamber.

5. The method of claim 4, including the step of combusting said one or more fuels in said fluid stream in a visible flame to cause said heating of said refractory lining and then increasing mixing of said one or more fuels with combustion air in said fluid stream to extinguish said visible flame and cause said flameless thermal oxidation of said components in said fluid stream.

6. The method of claim 5, including the step of including volatile organic compounds, semi-volatile organic compounds, and/or hazardous air pollutants as said additional components in said fluid stream.

7. The method of claim 6, including the step of adding said volatile organic compounds, semi-volatile organic compounds, and/or hazardous air pollutants to said fluid stream from a process stream.

8. The method of claim 7, including the step of adding at least a portion of said process stream to said fluid stream at a location within said oxidation chamber.

9. The method of claim 7, including the step of adding at least a portion of said process stream to said fluid stream prior to introducing said fluid stream into said oxidation chamber.

10. The method of claim 4, including the step of premixing at least a portion of said one or more fuels with combustion air in said fuel stream prior to introducing said fluid stream into said oxidation chamber.

11. The method of claim 10, including introducing another fluid stream containing one or more of said fuels to said oxidation chamber and burning said one or more fuels in said another fluid stream in said oxidation chamber in a visible flame to add supplemental heat to said oxidation chamber.

12. The method of claim 1, including repeating steps (a) and (b) in sequence.

13. The method of claim 1, including the step of maintaining said flameless oxidation for a period of time greater than one hour.

14. The method of claim 3, wherein said step of including one or more fuels among said components in said fluid stream comprises including a fuel selected from one or more of the group consisting of hydrogen, methane, ethane, propane, butane, and carbon dioxide.

15. The method of claim 3, wherein said step of including one or more fuels among said components in said fluid stream comprises including natural gas as one of said one or more fuels.

16. The method of claim 1, including the step of preheating at least a portion of fluid stream before said step of passing said fluid stream through said oxidation chamber.

17. The method of claim 4, wherein said step of heating the refractory lining comprises heating the refractor lining to a temperature within the range of 1,800 to 2,200 degrees F. and wherein the step of including one or more fuels comprises the step of including natural gas among said components in the fluid stream.

18. The method of claim 1, wherein the step of heating said refractory lining in the oxidation chamber comprises the steps of creating hot flue gases by burning natural gas in a burner which is in fluid-flow communication with said oxidation chamber, and delivering the hot flue gases into said oxidation chamber to heat said refractory lining to said preselected temperature.

19. The method of claim 18, including the steps of introducing said natural gas into an interior chamber of said burner at a first location and introducing combustion air into said interior chamber at a second location a preselected distance upstream from said first location during said step of heating said refractory lining in the oxidation chamber.

20. The method of claim 19, including the step of causing more complete mixing of said natural gas and said combustion air during said step of passing said fluid stream through the oxidation chamber to cause flameless oxidation of said natural gas in the oxidation chamber.

21. The method of claim 1, including the step of preventing recirculation of said fluid stream.

22. A method for thermally oxidizing components of a fluid stream containing one or more fuels in an oxidation chamber having an internal refractory lining, said method comprising the steps of:
(a) providing a fluid stream comprising one or more fuels and combustion air;
(b) heating said refractory lining in the oxidation chamber to a preselected temperature; and
(c) then passing said fluid stream through said oxidation chamber while maintaining the concentration of said one or more fuels below the lower flammability limit while said fluid stream is passing through said oxidation chamber to cause flameless thermal oxidation of said components in said fluid stream as a result of thermal radiation from said refractory lining and without recirculation of said fluid stream.

23. The method of claim 22, including repeating steps (b) and (c) in sequence.

24. The method of claim 22, wherein said step of providing a fluid stream comprises providing a fluid stream comprising methane and combustion air.
